(19) United States
(12) Patent Application Publication
(10) Pub. No.: US 2005/0164090 A1
(43) Pub. Date: Jul. 28, 2005

(54) Negative active material for a lithium secondary battery, a method of preparing the same, and a lithium secondary battery comprising the same

(76) Inventors: Joon-Sup Kim, Suwon-si (KR); Sung-Soo Kim, Suwon-si (KR); Sang-Jin Kim, Suwon-si (KR); Sang-Min Lee, Suwon-si (KR); Kyou-Yoon Sheem, Suwon-si (KR); Goo-Jin Jeong, Suwon-si (KR)

Correspondence Address: Robert E. Bushnell, Suite 300, 1522 K Street, N.W., Washington, DC, 20005, US

(21) Appl. No.: 11/042,330

(22) Filed: Jan. 26, 2005

(30) Foreign Application Priority Data
Jan. 26, 2004 (KR) 10-2004-0004666

(51) Int. Cl. H01M 4/62; H01M 4/48

(52) U.S. Cl. 429/232; 429/231.2; 429/231.5; 252/182.1

(57) ABSTRACT

The present invention relates to a negative active material for a lithium secondary battery which includes a metal oxide-based core material and a carbon material disposed on the surface of the core material, a method of preparing the same, and a lithium secondary battery including the negative active material. According to the present invention, a negative active material for a lithium secondary battery is prepared by coating a core material having good energy density per unit volume with a carbon material, thereby improving the cycle life and charge-discharge characteristics of a lithium secondary battery at a high rate.

### CLAIM OF PRIORITY

This application makes reference to, incorporates the same herein, and claims all benefits accruing under 35 U.S.C. §119 from an application for NEGATIVE ACTIVE MATERIAL FOR LITHIUM SECONDARY BATTERY, METHOD OF PREPARING SAME, AND LITHIUM SECONDARY BATTERY COMPRISING SAME earlier filed in the Korean Intellectual Property Office on 26 Jan. 2004 and there duly assigned Serial No. 10-2004-0004666.

### BACKGROUND OF THE INVENTION

1. Technical Field

The present invention relates to a negative active material for a lithium secondary battery, a method of preparing the same, and a lithium secondary battery comprising the same, and, more specifically, to a negative active material for a lithium secondary battery having prominent cycle life and charge-discharge characteristics at a high rate, a method of preparing the same, and a lithium secondary battery comprising the same.

2. Description of the Related Art

Recently, due to reductions in size and weight of portable electronic equipment and the need for batteries with both a high energy density and a high power density, there has been an increased use of lithium secondary batteries as a power source for electronic equipment. A lithium secondary battery using an organic electrolyte not only has been proven to have a high energy density, but also shows more than twice as high a discharge voltage as conventional batteries using an alkali aqueous solution as an electrolyte.

In general, oxides including lithium and a transition metal that can intercalate lithium, such as LiCoO₂, LiMn₂O₄, and LiNi₁₋ₓCoxO₂ (0<x<1), have been used as a positive active material.

As for a negative active material, various types of carbon-based materials, such as hard carbon and artificial and natural graphite, have been used. Such materials can intercalate and deintercalate lithium ions. Graphite is most comprehensively used among the aforementioned carbon-based materials. Graphite guarantees better cycle life for a battery due to its outstanding reversibility, as well as its provision of advantageous energy density, because it has a low discharge voltage of −0.2V compared to lithium. Accordingly, a battery using graphite as a negative active material has a high discharge voltage of 3.6V. However, a graphite active material has a low density (its theoretical density is 2.2 g/cc), and consequently a low capacity in terms of energy density per unit volume of an electrode, and it involves some dangers, such as explosion or combustion, when a battery is misused or overcharged and the like because graphite is likely to react to an organic electrolyte at a high discharge voltage.

In order to solve those problems, a great deal of research on an oxide negative electrode has recently been performed. Fuji Film developed an amorphous tin oxide. Although it had a high capacity per weight (800 mAh/g), it resulted in some critical defects as follows: a high initial irreversible capacity of up to 50%, a high electric potential of over 0.5 V, and a smooth voltage profile, which is unique in the amorphous phase. Consequently, it was hard to establish tin oxide as being applicable to a battery. Furthermore, some of the tin oxide tended to be reduced to tin metal during the charge or discharge reaction, which further reduced its acceptance for use in a battery.

Referring to another oxide negative electrode, a negative active material of LiₐMg_{b}VO_{c} (0.05≦a≦3, 0.12≦b≦2, 2≦2c-a-2b≦5) is disclosed in Japanese Patent Publicat No. 2002-216753 (SUMITOMO METAL IND LTD). The characteristics of a lithium secondary battery comprising Li_{1.1}V_{0.9}O₂ were also presented in the 2002 Japanese Battery Conference (Preview No. 3B05).

However, all these efforts did not satisfy the requirements for a qualifying battery, and still left many challenges for future research.

### SUMMARY OF THE INVENTION

An aspect of the present invention is to provide a negative active material for a lithium secondary battery with outstanding cycle life and charge-discharge characteristics at a high rate, and a method of preparing the same.

Another aspect of the present invention is to provide a lithium secondary battery comprising the aforementioned negative active material.

In order to accomplish these purposes, the present invention provides a negative active material for a lithium secondary battery, including a metal oxide-based core material and a carbon material on the core material.

The present invention also provides a negative electrode for a lithium secondary battery comprising the negative active material.

The present invention also provides a negative active material for a lithium secondary battery including a metal oxide-based core material and a carbon material, and a negative electrode for a lithium secondary battery comprising the negative active material.

The present invention also provides a method of preparing a negative active material for a lithium secondary battery, which method includes: a first step in which a metal oxide-based core material is mixed with a carbon material precursor; and a second step in which the resulting mixture is heat-treated, and thus a carbon material is formed on the surface of the core material.

The present invention also provides a method of preparing a negative active material for a lithium secondary battery, the method including: a first step in which a metal oxide is prepared; and a second step in which the resulting metal oxide is mixed with a carbon material.

The present invention also provides a lithium secondary battery, including: a positive electrode comprising a positive active material with the capability of intercalation and deintercalation of lithium ions; a negative electrode comprising the aforementioned negative active material; and an electrolyte.

### BRIEF DESCRIPTION OF THE DRAWING

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional perspective illustrating one embodiment of a lithium secondary battery of the present invention.

FIG. 2 is a graph showing an X-ray diffraction pattern of the negative active material according to Example 1.

FIG. 3 is a graph showing an X-ray diffraction pattern of the negative active material according to Example 3.

FIG. 4 is a graph showing an X-ray diffraction pattern of the negative active material according to Comparative Example 1.

FIG. 5 is a graph showing X-ray diffraction patterns of the negative electrodes according to Examples 1 and 3, and Comparative Example 1.

FIG. 6 is a graph showing charge-discharge characteristics of Example 1 and Comparative Example 1.

FIG. 7 is a graph showing Raman spectra of negative active materials according to Examples 6 and 7 of the present invention, and Comparative Example 4.

FIG. 8A is a scanning electron microscope (SEM) picture of a core material, prepared according to Example 7 of the present invention, before coating with a carbon material.

FIG. 8B is a scanning electron microscope (SEM) picture of a core material, prepared according to Example 7 of the present invention, after coating with a carbon material.

### DETAILED DESCRIPTION OF THE INVENTION

According to one embodiment of the present invention, a negative active material includes a metal oxide-based core material and a carbon material on the surface of the core material.

According to another embodiment of the present invention, a negative active material includes a metal oxide and a carbon material.

The metal oxide includes more than one selected from lithium-vanadium-based metal oxides represented by the following formula (1) or tin oxide:
LiₐM_{b}V_{c}O_{2+d} (1)
where a, b, c, and d are in the ranges of 0.1≦a≦2.5, 0≦b≦0.5, 0.5≦c≦1.5, 0≦d≦0.5; and M is more than one metal selected from the group consisting of Al, Cr, Mo, Ti, W, and Zr.

The lithium-vanadium-based metal oxide in formula (1) has a cycle life and discharge potential similar to those of graphite. In the metal oxide, Co in the structure of lithium-cobalt oxide is substituted with another transition metal, V, other than Li, and with another secondary metal element such as Al, Mo, W, Ti, Cr, or Zr. Especially, when a lithium-vanadium-based metal oxide is used as the core material of a negative active material, the capacity per unit volume is increased by over 1000 mAh/cc. The metals Mo and W, as a metal substitute represented by M in formula (1), are more advantageous than the others.

When the aforementioned material in the formula (1) has a, b, c, and d values outside the above ranges, its average potential goes up high over 1.0 V compared to that of lithium, and subsequently, a battery using it as a negative active material has too low a discharge voltage. For example, the use of a lithium-free metallic vanadium oxide compound, with a value under 0.1, as a negative active material is discussed in Solid State Ionics, 139, 57˜65 (2001), and in Journal of Power Source, 81˜82, 651˜655 (1999). However, the active material is difficult to use as a negative active material since it has a high average discharge potential of over 1 V. The crystalline structure of the negative active material is also known to be different from that of the negative active material according to the present invention.

In addition, non-limiting examples of the aforementioned tin oxide include more than one compound selected from the group consisting of SnO, SnO₂, Sn₂O₃, Sn₃O₄, Sn₇O₁₃, and SnO4, and more preferably SnO₂, due to high density (d=96.9 g/cc) and high capacity of approximately 800 mAh/g.

Tin oxide can exhibit a high capacity through a reaction with lithium, and it is possible to improve the properties of the negative active material by coating the surface of the tin oxide with a carbon layer.

In order to improve conductivity of the negative active material, a carbon layer is formed on the surface of the aforementioned core material to obtain a negative active material for a lithium secondary battery. The carbon layer has a strength ratio of Raman spectrum peak I(1360)/I(1580) ranging from 0.01 to 10, when the strengths of Raman spectrum peaks at 1360 cm⁻¹ and 1580 cm⁻¹ are I(1360) and I(1580), respectively. When the ratio I(1360)/I(1580) is under 0.01, efficiency may deteriorate, while when it is over 10, capacity may deteriorate.

The carbon material of the carbon layer can be either crystalline carbon or amorphous carbon.

Crystalline carbon includes a flat, spherical, or fiber type of natural or artificial graphite, and the like. Amorphous carbon includes soft or hard carbon, and the like.

Soft carbon can be obtained by heat-treating coal-based pitch, petroleum-based pitch, tar, or heavy oil with low molecular weight, while hard carbon can be obtained by heat-treating phenolic resin, naphthalene resin, polyvinylalcohol resin, urethane resin, polyimide resin, furan resin, cellulose resin, epoxy resin, or polystyrene resin.

Carbon material is used in an amount of 0.01 to 50 wt %, advantageously 0.01 to 15 wt %, and more advantageously 1 to 15 wt % based on the core material. When the amount of carbon is under 0.01 wt %, efficiency may deteriorate, while when the amount of carbon is over 50 wt %, capacity may deteriorate.

In addition, the advantageous thickness of the carbon layer on the surface of the core material is in the range of 1 nm to 5 μm, but the range of 10 nm to 1 μm is more advantageous. When the thickness is under 1 nm, efficiency may deteriorate, while when it is over 5 μm, capacity may deteriorate.

When the negative active material of the present invention includes a mixture of metal oxide and carbon material, the carbon material is included advantageously in an amount of 1 to 99 wt %, and more advantageously in an amount of 10 to 90 wt %, based on the negative active material.

The negative active material has a strength ratio of X-ray diffraction peaks M(003)/G(002) ranging from 0.01 to 100, and advantageously from 1 to 50, when the peak strength at plane (003) of the metal oxide is M(003) and the peak strength at plane (002) of the carbon material is G(002). When the ratio M(003)/G(002) is under 0.01, capacity per volume may deteriorate, while when it is over 100, cycle life characteristics may deteriorate.

Negative active material of the present invention can be charged at constant current and constant voltage as in the case of conventional carbon (graphite), and it manifests the capacity through the same method, unlike recently researched metal or metal/graphite composite active materials. When constant current and constant voltage are applied to metal or metal/graphite composite active materials, the properties of the materials deteriorate because of the destruction of the crystalline structure, or ions are deposited on the surface, rather than diffused into the structure, due to the different mechanism of intercalation/deintercalation from graphite. Therefore, these materials have a high capacity but seriously defective reversibility and safety.

Conversely, the negative active material of the present invention can be used as a negative electrode of a lithium secondary battery since it can be charged at constant current and constant voltage, while it is difficult to use the recently-researched metal or metal/graphite composite negative active material for a battery since it cannot be charged at a constant voltage, unlike conventional graphite negative active material. In addition, the negative active material shows better safety with the organic electrolyte than general carbon-based negative active materials.

Additionally, the metal oxide of the negative active material has a theoretical energy density per unit volume of 4.2 g/cc, and thus an actual electrode density of about 3.0 g/cc. When capacity per unit weight of the metal oxide is 300 mAh/g, theoretical capacity per unit volume of the metal oxide is greater than or equal to 1200 mAh/cc, and actual capacity per unit volume of the metal oxide is greater than or equal to about 900 mAh/cc.

Conversely, the conventional graphite negative active material has a theoretical energy density per unit volume of 2.0 g/cc, and thus an electrode density of about 1.6 g/cc. The actual capacity per unit weight of the graphite is 360 mAh/g, and the actual capacity per unit volume of the graphite is 570 mAh/cc. Therefore, the negative active material of the present invention has about twice the energy density compared to the conventional negative active material.

According to still another embodiment of the present invention, a method of preparing a negative active material for a lithium secondary battery includes: a first step in which a metal oxide-based core material is mixed with a carbon material precursor; and a second step in which the resulting mixture is heat-treated, and thus carbon material is formed on the surface of the core material.

The amount of the carbon material coated on the core material is 0.01 to 50 wt % based on the core material, but it advantageously ranges from 0.01 to 15 wt %, and more advantageously ranges from 1 to 15 wt %. When the amount of carbon is under 0.01 wt %, efficiency may deteriorate, while when the amount of the carbon is over 50 wt %, capacity may deteriorate.

In addition, the advantageous thickness of the carbon layer on the surface of the core material is in the range of 1 nm to 5 μm, but the range of 10 nm to 1 μm is more advantageous. When the thickness is under 1 nm, efficiency may deteriorate, while when it is over 5 μm, capacity may deteriorate.

Carbon material has an advantageous strength ratio of Raman spectrum peak I(1360)/I(1580) ranging from 0.01 to 10, when the strengths of Raman spectrum peaks at 1360 cm⁻¹ and 1580 cm⁻¹ are I(1360) and I(1580), respectively.

The carbon material can be formed by heat-treating the mixture of a core material with a carbon material precursor. The advantageous temperature is in the range of 500 to 1400° C., but the range of 500 to 1000° C. is more advantageous. When the temperature is under 500° C., sufficient carbonization may not occur, and the coating of a carbon material may not be realized. When the temperature is over 1400° C., the core material could decompose. On the other hand, when the temperature is over 1000° C., the carbon material may crystallize.

As for the carbon material precursor used for the coating of the carbon material, at least one selected from the following group can be used: various resin types, such as phenolic resin, naphthalene resin, polyvinylalcohol resin, urethane resin, polyimide resin, furan resin, cellulose resin, epoxy resin, or polystyrene resin; and coal-based pitch, petroleum-based pitch, tar, or heavy oil with a low molecular weight, and the like. However, it is to be understood that the carbon material precursor of the present invention is not limited thereto.

According to yet another embodiment of the present invention, a negative active material coated with a carbon material is prepared by mixing a core material and crystalline carbon in a solid phase or liquid phase while performing a coating process. The method includes mixing the core material and crystalline carbon, and coating the core material with the crystalline carbon.

The mixing step in the solid-phase may be performed by mechanically mixing the core material with crystalline carbon. The mechanical mixing includes kneading, mechanical mixing using a mixer having a modified wing structure, in contrast to a conventional mixer, so as to provide shear stress to the mixture, or mechanochemical mixing where shear strength is applied to particles in order to cause fusion between particle surfaces.

The mixing step in the liquid-phase process may be performed either by mechanically mixing the above core material with crystalline carbon, or by mixing by spray-drying, spray-pyrolysis, or freeze-drying. The organic solvent includes water, an organic solvent, or a mixture thereof. The organic solvent includes ethanol, isopropyl alcohol, toluene, benzene, hexane, tetrahydrofuran, or the like.

As for the metal oxide core material used for the preparation of the negative active material, one or two selected from tin oxide or lithium-vanadium-based metal oxide represented by the formula (1) may be used.
LiₐM_{b}V_{c}O_{2+d} (1)
where a, b, c, and d are in the ranges of 0.1≦a≦2.5, 0≦b≦0.5, 0.5≦c≦1.5, 0≦d≦0.5; and M is more than one metal selected from the group consisting of Al, Cr, Mo, Ti, W, and Zr,

The lithium-vanadium-based metal oxide can be prepared through the steps of: mixing a lithium-containing source, a vanadium-containing source, and a metal-containing source; and heat-treating the mixture under a reducing atmosphere at the temperature of 500 to 1400° C.

The mixing ratio of the lithium-containing source, the vanadium-containing source, and the metal-containing source can be regulated according to the composition ratio of each component of the lithium-vanadium-based metal oxide represented by formula (1).

As for the lithium-containing source, any material including a lithium element can be used, and more than one can advantageously be selected from the group consisting of lithium carbonate, lithium hydroxide, lithium nitrate, or lithium acetate.

As for the vanadium-containing source, more than one material selected from the group consisting of vanadium metal, VO, V₂O₃, V₂O₄, V₂O₅, V₄O₇, VOSO₄.nH₂O or NH₄VO₃ and the like can be used.

As for the metal-containing source, an oxide or a hydroxide including more than one metal element selected from the group consisting of Al, Cr, Mo, Ti, W, or Zr can be used. More than one can advantageously be selected from the group of Al(OH)₃, Al₂O₃, Cr₂O₃, MoO₃, TiO₂, WO₃, and ZrO₂.

The aforementioned mixture is heat-treated at a temperature of 500 to 1400° C., and more advantageously at 900 to 1200° C., to prepare the lithium-vanadium-based metal oxide represented by formula (1). When the temperature is out of the range of 500 to 1400° C., an impurity phase, for example, Li₃VO₄ and the like, can be formed, which may result in reducing the cycle life and the capacity of a battery.

The reducing atmosphere includes nitrogen, an argon atmosphere, an N₂/H₂-mixed gas, a CO/CO₂-mixed gas, or a helium atmosphere. In addition, the advantageous partial pressure of oxygen in the reducing atmosphere is under 2×10⁻¹ atm. When it is greater than or equal to 2×10⁻¹ atm, it could be very problematic because the reducing atmosphere is changed into an oxidization atmosphere in which a metal oxide can be oxidized. That is, the metal oxide could be synthesized into other oxygen-rich phases or mixed with oxygen together with more than two other impurity phases.

Another core material, tin oxide, is more than one compound selected from the group consisting of SnO, SnO₂, Sn₂O₃, Sn₃O₄, Sn₇O₁₃, and SnO₄, and more preferably SnO₂, due to high density (d=96.9 g/cc) and high capacity of approximately 800 mAh/g.

The tin oxides can be prepared by combustion of organic tin compounds, such as tin chloride, tin sulfate, or tin acetate, under an air atmosphere. The tin oxides are also commercially available, and thus a detailed description of a method of preparing them is omitted.

According to a further embodiment of the present invention, a negative active material is coated by preparing a metal oxide, and by mixing the metal oxide and a carbon material.

The metal oxide and a preparation method thereof, and the carbon material, are the same as described above. Hereinafter, the mixing process is described in more detail.

The above mixing step may be carried out in either a solid-phase or a liquid-phase process.

The mixing step in the solid-phase process maybe performed by mechanically mixing the core material with crystalline carbon. The mechanical mixing includes kneading, mechanical mixing using a mixer having a modified wing structure, in contrast to a conventional mixer, so as to provide shear stress to the mixture, or mechanochemical mixing where shear strength is applied to particles in order to cause fusion between particle surfaces.

The mixing step in the liquid-phase process may be performed either by mechanically mixing the core material with crystalline carbon as above, or by mixing by spray-drying, spray-pyrolysis, or freeze-drying. The organic solvent includes water, an organic solvent, or a mixture thereof. The organic solvent includes ethanol, isopropyl alcohol, toluene, benzene, hexane, tetrahydrofuran, or the like.

According to another embodiment of the present invention, a lithium secondary battery includes a negative electrode comprising the aforementioned negative active material. The negative electrode is prepared by coating a negative material slurry, prepared by mixing the above negative active material, a conductive agent such as graphite and the like, and a binder, on the current collector, such as copper and the like.

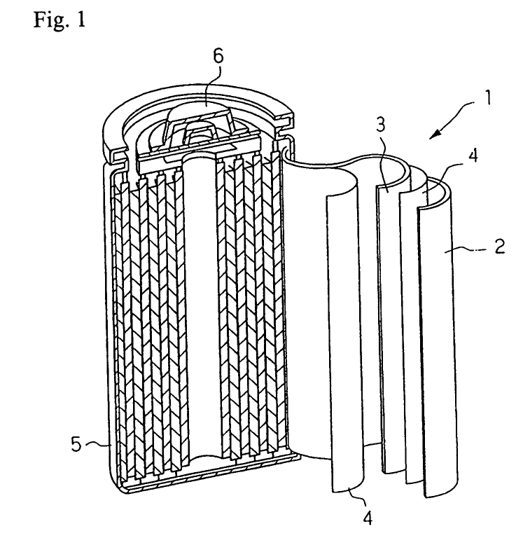

FIG. 1 is a partial cross sectional perspective view showing one embodiment of a lithium secondary battery of the present invention. According to this embodiment of the present invention, the secondary battery 1 comprises a negative electrode 2, a positive electrode 3, a separator 4 interposed between the electrodes 2 and 3, an electrolyte which is impregnated in the negative electrode 2 and the positive electrode 3, a separator 4, a container 5, and a sealing member 6 sealing the container 5. FIG. 1 illustrates battery 1 of cylindrical shape, but the battery is not limited to this type. The battery can be a prismatic, coin, or sheet type battery, for example.

The positive electrode 3 includes a positive active material which is capable of performing intercalation or deintercalation of lithium ions. The positive active material can be selected from the group represented by the formulas (2) to (13):
LiₓMn_{1-y}MyA₂ (2);
LiₓMn_{1-y}MyO_{2-z}X_{z} (3);
LiₓMn₂O_{4-z}X_{z} (4);
LiₓCo_{1-y}M_{y}A₂ (5);
LiₓCo_{1-y}M_{y}O_{2-z}X_{z} (6);
LiₓNi_{1-y}M_{y}A₂ (7);
LiₓNi_{1-y}M_{y}O_{2-z}X_{z} (8);
LiₓNi_{1-y}Co_{y}O_{2-z}X_{z} (9);
LiₓNi_{1-y-z}Co_{y}M_{z}A_{w} (10);
LiₓNi_{1-y-z}Co_{y}M_{z}O_{2-w}X_{w} (11);
LiₓNi_{1-y-z}Mn_{y}M_{z}A_{w} (12);
LiₓNi_{1-y-z}Mn_{y}M_{z}O_{2-w}X_{w} (13)
where x, y, z, and w in the above formulas are in the ranges of 0.90≦x≦1.1, 0≦y≦0.5, 0≦z≦0.5, and 0≦w≦2; M is at least one element selected from the group consisting of Al, Ni, Co, Mn, Cr, Fe, Mg, Sr, V, and rare earth elements; A is an element selected from the group consisting of O, F, S, and P; and the X is F, S, or P.

A lithium secondary battery according to the present invention includes a positive electrode prepared by the aforementioned positive active material. The positive electrode is fabricated by coating, on the current collector, a positive active material slurry prepared by mixing the positive active material, a conductive agent and a binder.

Any electronic conductive material can be used as the conductive agent unless it causes a chemical change, for example, natural graphite, artificial graphite, carbon black, acetylene black, ketjen black, carbon fiber, metal powder or metal fiber including copper, nickel, aluminum, and silver. In addition, a conducting material such as a polyphenylene derivative can be used (disclosed in Japanese Laid Open Patent Sho 59-20971 for example) with one or more of the above listed conductive agents.

As for the binder, polyvinylalcohol, carboxymethyl cellulose, hydroxypropylene cellulose, diacetylene cellulose, polyvinyl chloride, polyvinyl pyrrolidone, polytetrafluoroethylene, polyvinylidenefluoride, polyethylene, or polypropylene can be used, but it is not limited thereto.

As for the separator, an olefin-based porous film such as polyethylene, polypropylene, and the like can be used.

The electrolyte of the present invention includes an organic solvent and a lithium salt.

The electrolyte functions as a medium so that the ions involved in the electrochemical reaction of a battery can freely move. As for the electrolyte, an organic solvent such as a carbonate, ester, ether, or ketone and the like can be used. As for the carbonate, dimethyl carbonate, diethylcarbonate, dipropylcarbonate, methylpropylcarbonate, ethylpropyl carbonate, methylethylcarbonate, ethylene carbonate, propylene carbonate, and butylenes carbonate, and the like can be used. As for the ester, γ-butyrolactone, decanolide, valerolactone, mevalonolactone, caprolactone, n-methyl acetate, n-ethyl acetate, n-propyl acetate, and the like can be used. As for the ether, dibutyl ether and the like can be used. However, it is understood that the above are not limiting examples. The organic solvent can be used alone, or as a mixture of more than one, as an electrolyte. The mixing ratio can be appropriately regulated according to the intended battery capacity.

The electrolyte can include an aromatic carbonate-based hydrogen-based organic solvent other than the aforementioned ones. For example, benzene, fluorobenzene, toluene, fluorotoluene, trifluorotoluene, xylene, and the like can be used.

Lithium salt can use, as a supporting salt, more than one selected from the group consisting of LiPF₆, LiBF₄, LiSbF₆, LiAsF₆, LiCF₃SO₃, LiN(CF₃SO₂)₃, Li(CF₃SO₂)₂N, LiCF₉SO₃, LiClO₄, LiAlO₄, LiAlCl₄, LiN(CₘF₂ₘ₊₁SO₂)(CₙF₂ₙ₊₁SO₂) (where m and n are natural numbers), LiCl, and LiI. These supporting salts are dissolved into the organic solvent wherein they work as a source of lithium ions, making it possible for a lithium secondary battery to basically function, and to promote the movement of lithium ions between positive and negative electrodes. The concentration of lithium salt in the electrolyte advantageously ranges from 0.1 to 2.0 M.

The following examples further illustrate embodiments of the present invention. However, it is to be understood that the examples are for illustration purposes only, and that the invention is not limited to the examples.

### EXAMPLE 1

Li₂CO₃, V₂O₃, and MoO₃ were mixed in a Li:V:Mo mole ratio of 1.08:0.9:0.02 in solid-phase. The mixture was heat-treated at a temperature of 1000° C. for 10 hours under a nitrogen atmosphere, and cooled to room temperature to prepare a metal oxide.

After a crystalline carbon material, natural graphite, was ground finely, 150 g of graphite was uniformly mixed with 150 g of the prepared metal oxide in a planetary mixer to obtain a negative active material.

### EXAMPLE 2

A negative active material was prepared by the same method as in Example 1, except that Li₂CO₃, V₂O₃, and WO₃ were mixed in a Li:V:W mole ratio of 1.12:0.85:0.05 in solid-phase.

### EXAMPLE 3

Li₂CO₃, V₂O₃, and MoO₃ were mixed in a Li:V:Mo mole ratio of 1.08:0.9:0.02 in solid-phase. The mixture was heat-treated at a temperature of 1000° C. for 10 hours under a nitrogen atmosphere, and cooled to room temperature to prepare a metal oxide.

After a crystalline carbon material, natural graphite, was ground finely, 210 g of graphite was uniformly mixed with 90 g of the prepared metal oxide in a planetary mixer to obtain a negative active material.

### COMPARATIVE EXAMPLE 1

Li₂CO₃, V₂O₃, and MoO₃ were mixed in a Li:V:Mo mole ratio of 2:0.9:0.01 in solid-phase. The mixture was heat-treated at a temperature of 1000° C. for 10 hours under a nitrogen atmosphere, and cooled to room temperature to prepare a metal oxide as a negative active material.

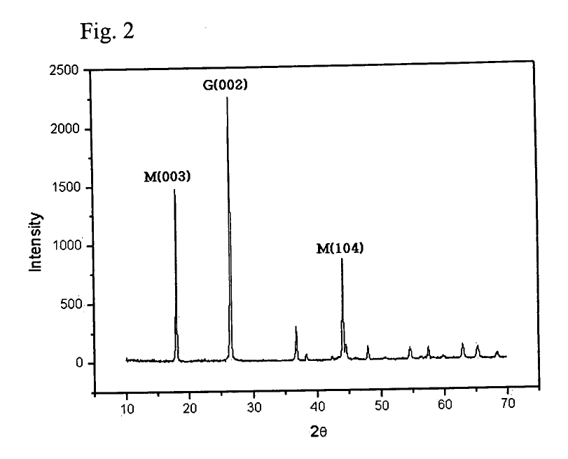

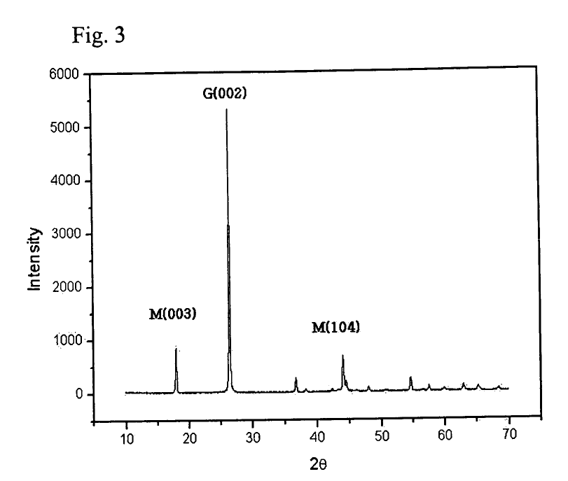

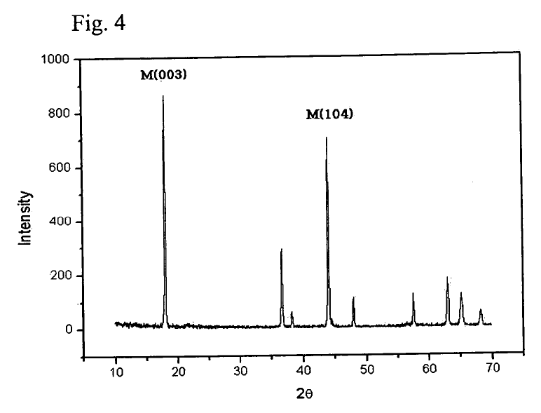

FIG. 2 is a graph showing an X-ray diffraction pattern of the negative active material according to Example 1, FIG. 3 is a graph showing an X-ray diffraction pattern of the negative active material according to Example 3, and FIG. 4 is a graph showing an X-ray diffraction pattern of the negative active material according to Comparative Example 1.

As shown in FIGS. 2 and 3, M(003) and G(002) are proportional to the amount of metal oxide and graphite, respectively.

Preparation of a Test Cell for the Charge-Discharge Evaluation

Negative active material slurries were prepared by mixing negative active materials, prepared in Examples 1 to 3, and polyvinylidene fluoride (PVDF) in a ratio of 90:10 in N-methylpyrrolidone (NMP). A negative active material slurry was also prepared by mixing the negative active material, prepared in Comparative Example 1, Super-P (3M Company), and polyvinylidene fluoride (PVDF) in a ratio of 80:10:10 in N-methylpyrrolidone (NMP).

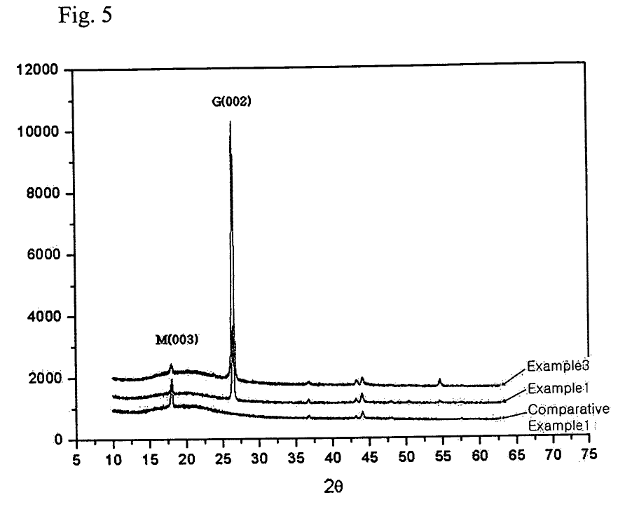

The slurry was coated on a copper current collector to fabricate a negative electrode with a thickness of 40 to 50 μm (including the thickness of the current collector), was dried under vacuum at a temperature of 135° C. for 3 hours, and was compressed. X-ray diffraction patterns of the negative electrodes, including the negative active materials of Examples 1 and 3 and Comparative Example 1, are shown in FIG. 5.

Coin-type cells were fabricated by arraying the negative electrode, as a working electrode, and a lithium foil with a circular shape of the same diameter as a counter electrode, inserting a separator made of a porous polypropylene film between these two electrodes, and using an electrolyte prepared by dissolving 1 mol/L LiPF₆ in a mixed solvent of propylenecarbonate (PC), diethylcarbonate (DEC), and ethylenecarbonate (EC) (PC: DEC: EC=1:1:1).

The electrochemical performance of the coin-type cells was evaluated under the condition of 0.2C⇄0.2C (one cycle) at a voltage between 0.01 V to 2.0 V, 0.2C⇄0.2C (one cycle) at a voltage between 0.01 V to 1.0 V, and 1C⇄1C (50 cycles) at a voltage between 0.01 V to 1.0 V. The cycle life of a cell was represented as the percentage of the capacity after its 50 charge and discharge cycles at 1 C relative to the initial capacity. The measurement results are shown in Table 1.

TABLE 1

| | | Initial | Initial | 50th | |
|---|---|---|---|---|---|
| | Electrodedensity | capactiy | efficiency | capacity | Cycle |
| | [g/cc] | [mAh/cc] | [%] | [mAh/cc] | life(%) |
| Ex. 1 | 2.25 | 725 | 86 | 680 | 93.8 |
| Ex. 2 | 2.21 | 718 | 85 | 659 | 91.8 |
| Ex. 3 | 2.18 | 722 | 86 | 638 | 88.4 |
| Comp. | 2.45 | 503 | 80 | 293 | 58.3 |
| Ex. 1 | | | | | |

As shown in Table 1, even though the negative electrode which includes the negative active material prepared according to Comparative Example 1 has high electrode density, it has low capacity per weight (503 mAh/cc (2.45 g/cc=205 mAh/g).

However, the negative electrodes which include the negative active materials prepared according to Examples 1 to 3 have high capacity per volume (capacity per weight (mAh/g)×density of electrode (g/cc)=capacity per volume (mAh/cc)) by increasing capacity per weight.

Furthermore, cycle lives of the lithium secondary battery cells which include the negative active materials prepared according to Examples 1 to 3 are significantly improved because the negative active materials include graphites which have outstanding cycle life properties.

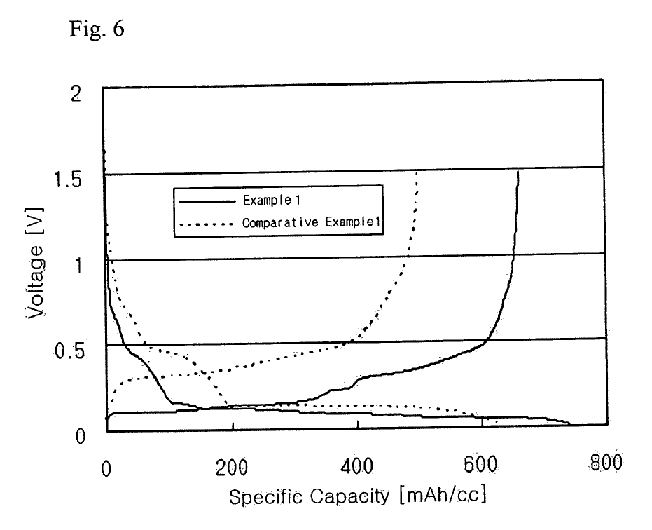

FIG. 6 is a graph showing charge-discharge characteristics of Example 1 and Comparative Example 1. As shown in FIG. 6, the capacity per volume of the negative electrode which includes the negative active materials prepared according to Example 1 is higher than that of the negative electrode which includes the negative active materials prepared according to Comparative Example 1.

### EXAMPLE 4

Li₂CO₃, MoO₃, and V₂O₄ were mixed in a Li:Mo:V mole ratio of 1.2:0.05:0.85. The mixture was heat-treated at a temperature of 1200° C. under a nitrogen atmosphere to prepare a core material of Li_{1.2}Mo_{0.05}V_{0.85}O₂.

Then, the above-prepared core material and petroleum-based pitch were mixed in a weight ratio of 9:1, treated with pitch, and then heat-treated at a temperature of 1000° C. for 5 hours to obtain a negative active material with a carbon material layer.

### EXAMPLE 5

A negative active material was prepared by the same method as in Example 4, except that a core material of Li_{1.3}Mo_{0.1}V_{0.8}O₂ prepared by changing the Li:Mo:V mole ratio to 1.3:0.1:0.8 was used.

### EXAMPLE 6

A negative active material was prepared by mixing 90 g of the core material in Example 4 and 10 g of a carbon material precursor, tar, and by heat-treating them at a temperature of 1000° C.

### EXAMPLE 7

Li₂CO₃, MoO₃, and V₂O₄ were mixed in a Li:Mo:V mole ratio of 1.2:0.05:0.85, and then heat-treated at a temperature of 1200° C. under a nitrogen atmosphere to prepare a core material of Li_{1.2}Mo_{0.05}V_{0.85}O₂.

A crystalline carbon material, natural graphite, was ground finely and then mixed with ethanol to obtain 10 g/L of a composition.

A negative active material with a carbon material layer was prepared by spraying the prepared composition on the core material and then drying it.

### EXAMPLE 8

A negative active material was prepared by the same method as in Example 7, except that a core material of Li_{1.3}Mo_{0.1}V_{0.8}O₂ was prepared by changing the Li:Mo:V mole ratio to 1.3:0.1:0.8.

### EXAMPLE 9

A negative active material was prepared by the same method as in Example 4, except that tin oxide (SnO₂) was used as a core material.

### EXAMPLE 10

A negative active material was prepared in the same method as in Example 6, except that tin oxide (SnO₂) was used as a core material.

### EXAMPLE 11

A negative active material was prepared by the same method as in Example 7, except that tin oxide (SnO₂) was used as a core material.

### COMPARATIVE EXAMPLE 2

A negative active material was prepared by the same method as in Example 4, except that graphite was used as a core material.

### COMPARATIVE EXAMPLE 3

A negative active material was prepared by the same method as in Example 4, except that a core material of Li₃VO₄ was prepared by changing the Li:V mole ratio to 3:1.

### COMPARATIVE EXAMPLE 4

Li₂CO₃, MoO₃, and V₂O₄ were mixed in a Li:Mo:V mole ratio of 1.2:0.05:0.85. The mixture was heat-treated at a temperature of 1200° C. under a nitrogen atmosphere to prepare a negative active material of Li_{1.2}Mo_{0.05}V_{0.85}O₂.

Evaluation of Negative Active Materials

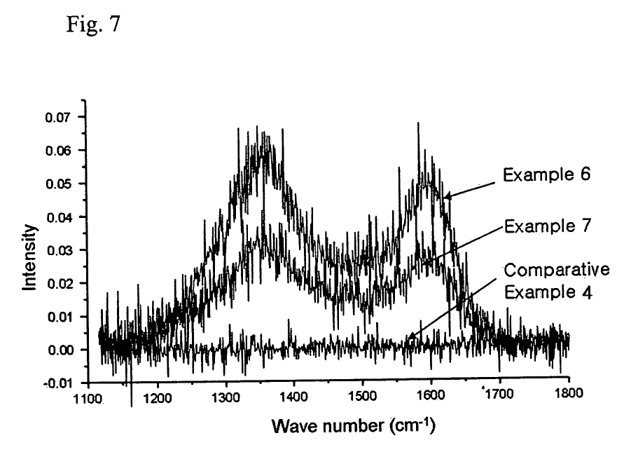

The Raman spectrum was measured with respect to each negative active material prepared according to Examples 4 to 11 and Comparative Examples 2 to 4. FIG. 7 is a graph showing the results of the measurements on the negative active materials in Examples 6 and 7 and Comparative Example 4.

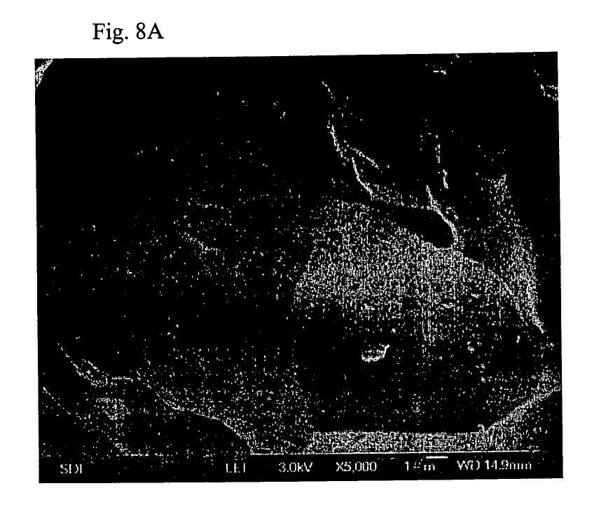

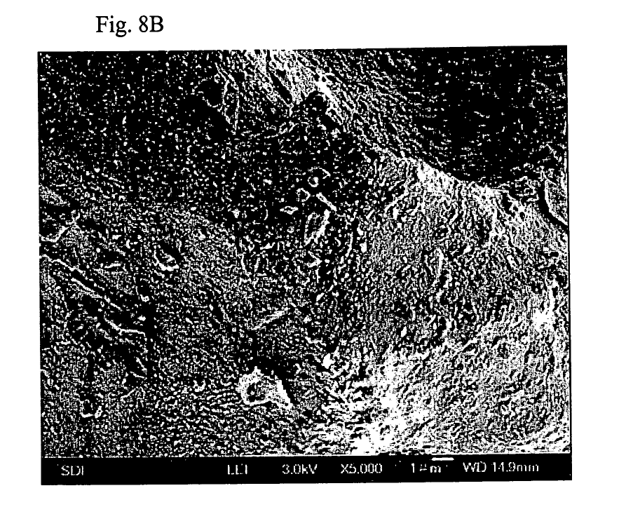

FIGS. 8A and 8B are scanning electron microscope (SEM) photographs respectively showing before and after coating with carbon material on the core material prepared in Example 7.

Preparation of a Test Cell for the Charge-Discharge Evaluation

Negative active material slurries were prepared by mixing negative active materials prepared in Examples 4 to 11 and Comparative Examples 2 to 4, graphite, and polyvinylidene fluoride (PVDF) in the ratio of 45:45:10 in N-methylpyrrolidone (NMP). The slurries were coated on copper current collectors with a thickness of 18 μm using a Doctor blade, and were dried under a vacuum at a temperature of 100° C. for 24 hours, volatilizing the N-methylpyrrolidone (NMP). The negative active materials were laminated on the copper current collectors to a thickness of 120 μm. Then, the negative electrodes were punched to a diameter of 13 mm.

Coin-type cells were fabricated by arraying the negative electrodes, as working electrodes, and a lithium foil with a circular shape of the same diameter as a counter electrode, inserting a separator made of a porous polypropylene film between these two electrodes, and using an electrolyte prepared by dissolving 1 mol/L LiPF₆ in a mixed solvent of propylenecarbonate (PC), diethylcarbonate (DEC), and ethylenecarbonate (EC) (PC: DEC: EC=1:1:1).

Each coin-type cell, including each negative active material prepared in Examples 4 to 11 and Comparative Examples 2 to 4, was fabricated by the aforementioned method. Then, the electrochemical performance of the coin-type cells was evaluated under the condition of 0.2C⇄0.2C (one cycle) at a voltage between 0.01 V to 2.0 V, 0.2C⇄0.2C (one cycle) at a voltage of between 0.01 V to 1.0 V, and 1C⇄1C (50 cycles) at a voltage of between 0.01 V to 1.0 V. The cycle life of a cell was represented as a percentage of the capacity after 50 charge and discharge cycles at 1 C relative to the initial capacity. The measurement results are shown in Table 2.

TABLE 2

| | Initial charge | Initial discharge | | |
|---|---|---|---|---|
| | capacity | capacity | Initial | Cycle |
| | (mAh/g) | (mAh/g) | efficiency(%) | life(%) |
| Example 4 | 362 | 325 | 90 | 93 |
| Example 5 | 368 | 321 | 87 | 95 |
| Example 6 | 355 | 315 | 89 | 85 |
| Example 7 | 358 | 313 | 87 | 90 |
| Example 8 | 360 | 321 | 89 | 88 |
| Example 9 | 1560 | 720 | 46 | 57 |
| Example 10 | 1480 | 715 | 48 | 61 |
| Example 11 | 1467 | 698 | 48 | 53 |
| Comparative | 320 | 288 | 90 | 90 |
| Example 2 | | | | |
| Comparative | 340 | 219 | 64 | 55 |
| Example 3 | | | | |
| Comparative | 350 | 315 | 90 | 50 |
| Example 4 | | | | |

Table 2 shows that lithium secondary battery cells which include the negative active materials prepared according to Examples 4 to 11 were outstanding in battery performance, such as initial charge capacity, initial discharge capacity, and cycle life.

As described above, a negative active material for a lithium secondary battery according to the present invention is prepared by coating a metal oxide core material having good energy density per unit volume with a carbon material, or mixing a metal oxide and a carbon material. The negative active materials can solve low capacity and efficiency problems of the metal oxide and have high density, and thus they provide a high density and high capacity lithium secondary battery and improve the cycle life and charge-discharge characteristics of a lithium secondary battery at a high rate.

The foregoing is considered illustrative only of the principles of the invention. Further, since numerous modifications and changes will readily occur to those skilled in the art, it is not desired to limit the invention to the exact construction and operation shown and described. Accordingly, all suitable modifications and equivalents that may be resorted to still fall within the scope of the invention and the appended claims.

1. A negative active material for a lithium secondary battery, comprising:
a metal oxide-based core material; and
a carbon material disposed on a surface of the core material.

2. The negative active material of claim 1, wherein the metal oxide-based core material comprises more than one selected from the group consisting of a lithium vanadium-based oxide represented by the following formula (1) and a tin oxide:
LiₐM_{b}V_{c}O_{2+d} (1)
wherein a, b, c, and d are in ranges of 0.1≦a≦2.5, 0≦b≦0.5, 0.5≦c≦1.5, 0≦d≦0.5; and
wherein M is more than one metal selected from the group consisting of Al, Cr, Mo, Ti, W, and Cr.

3. The negative active material of claim 2, wherein M is one of Mo and W.

4. The negative active material of claim 1, wherein a strength ratio of a Raman spectrum peak I(1360)/I(1580) of the carbon material ranges from 0.01 to 10, when strengths of Raman spectrum peaks at 1360 cm⁻¹ and 1580 cm⁻¹ are I(1360) and I(1580), respectively.

5. The negative active material of claim 1, wherein the carbon material is one of a crystalline and an amorphous carbon.

6. The negative active material of claim 1, wherein the carbon material is graphite.

7. The negative active material of claim 1, wherein an amount of the carbon material is in a range of 0.01 to 50 wt % based on the core material.

8. The negative active material of claim 6, wherein an amount of the carbon material is in a range of 0.01 to 15 wt % based on the core material.

9. The negative active material of claim 1, wherein the carbon material forms a carbon layer on the surface of the core material to a thickness in a range of 1 nm to 5 μm.

10. The negative active material of claim 1, wherein an amount of the carbon material is in a range of 1 to 99 wt % based on the negative active material.

11. A negative electrode for a lithium secondary battery, comprising the negative active material of claim 1.

12. A negative active material for a lithium secondary battery, comprising:
a metal oxide-based material; and
a carbon material.

13. The negative active material of claim 12, wherein a strength ratio of X-ray diffraction peaks M(003)/G(002) ranges from 0.01 to 100, when a peak strength at plane (003) of the metal oxide is M(003) and a peak strength at plane (002) of the carbon material is G(002).

14. The negative active material of claim 13, wherein a strength ratio of X-ray diffraction peaks M(003)/G(002) ranges from 1 to 50.

15. The negative active material of claim 12, wherein the metal oxide-based material comprises more than one selected from the group consisting of a lithium vanadium-based oxide represented by the following formula (1) and a tin oxide:
LiₐM_{b}V_{c}O_{2+d} (1)
wherein a, b, c, and d are in ranges of 0.1≦a≦2.5, 0≦b≦0.5, 0.5≦c≦1.5, 0≦d≦0.5; and
wherein M is more than one metal selected from the group consisting of Al, Cr, Mo, Ti, W, and Cr.

16. The negative active material of claim 15, wherein M is one of Mo and W.

17. The negative active material of claim 12, wherein a strength ratio of a Raman spectrum peak I(1360)/I(1580) of the carbon material ranges from 0.01 to 10, when strengths of Raman spectrum peaks at 1360 cm⁻¹ and 1580 cm⁻¹ are I(1360) and I(1580), respectively.

18. A method of preparing a negative active material for a lithium secondary battery, comprising the steps of:
mixing a metal oxide-based core material with a carbon material precursor to form a resulting mixture; and
heat-treating the resulting mixture to form a carbon material on a surface of the metal oxide-based core material.

19. The method of claim 18, wherein the metal oxide-based core material comprises more than one selected from the group consisting of a lithium vanadium-based oxide represented by the following formula (1) and a tin oxide:
LiₐM_{b}V_{c}O_{2+d} (1)
wherein a, b, c, and d are in ranges of 0.1≦a≦2.5, 0<b≦0.5, 0.5≦c≦1.5, 0≦d≦0.5; and
wherein M is more than one metal selected from the group consisting of Al, Cr, Mo, Ti, W, and Cr.

20. The method of claim 19, wherein M is one of Mo and W.

21. The method of claim 19, wherein the lithium vanadium-based oxide is prepared by a method comprising the steps of:
mixing a lithium-containing source, a vanadium-containing source, and a metal-containing source to form a mixture; and
heat-treating the mixture under a reducing atmosphere at a temperature in a range of 500° C. to 1400° C.

22. The method of claim 21, wherein the vanadium-containing source is at least one selected from the group consisting of vanadium metal, VO, V₂O₃, V₂O₄, V₂O₅, V₄O₇, VOSO₄.nH₂O, and NH₄VO₃.

23. The method of claim 21, wherein the lithium-containing source is at least one selected from the group consisting of lithium carbonate, lithium hydroxide, lithium nitrate, and lithium acetate.

24. The method of claim 21, wherein the metal-containing source is at least one selected from the group consisting of an oxide and a hydroxide including at least one selected from the group consisting of Al, Cr, Mo, Ti, W, and Zr.

25. The method of claim 21, wherein the reducing atmosphere is selected from the group consisting of a nitrogen atmosphere, an argon atmosphere, an N₂/H₂-mixed gas atmosphere, a CO/CO₂-mixed gas atmosphere, and a helium atmosphere.

26. The method of claim 18, wherein the carbon material forms a carbon layer on the surface of the core material to a thickness in a range of 1 nm to 5 μm.

27. The method of claim 18, wherein the step of heat-treating is performed at a temperature in a range of 500° C. to 1400° C.

28. The method of claim 27, wherein the step of heat-treating is performed at a temperature in a range of 500° C. to 1000° C.

29. The method of claim 27, wherein the carbon material precursor is at least one selected from the group consisting of phenolic resin, naphthalene resin, polyvinylalcohol resin, urethane resin, polyimide resin, furan resin, cellulose resin, epoxy resin, polystyrene resin, coal-based pitch, petroleum-based pitch, tar, and heavy oil with a low molecular weight.

30. A lithium secondary battery, comprising:
a positive electrode comprising a positive active material that is capable of intercalating and deintercalating lithium ions;
a negative electrode comprising a negative active material; and
an electrolyte;
wherein the negative active material comprises a metal oxide-based core material and a carbon material disposed on a surface of the core material.

31. The lithium secondary battery of claim 30, wherein the positive active material is at least one selected from the group consisting of formulas (2) to (13):
LiₓMn_{1-y}M_{y}A₂ (2);
LiₓMn_{1-y}M_{y}O_{2-z}X_{z} (3);
LiₓMn₂O_{4-z}X_{z} (4);
LiₓCo_{1-y}M_{y}A₂ (5);
LiₓCo_{1-y}M_{y}O_{2-z}X_{z} (6);
LiₓNi_{1-y}M_{y}A₂ (7);
LiₓNi_{1-y}M_{y}O_{2-z}X_{z} (8);
LiₓNi_{1-y}Co_{y}O_{2-z}X_{z} (9);
LixNi_{1-y-z}Co_{y}M_{z}A_{w} (10);
LixNi_{1-y-z}Co_{y}M_{z}O_{2-w}X_{w} (11);
LixNi_{1-y-z}Mn_{y}M_{z}A_{w} (12); and
LixNi_{1-y-z}Mn_{y}M_{z}O_{2-w}X_{w} (13)
wherein x, y, z, and w in the above formulas are in ranges of 0.90≦x≦1.1, 0≦y≦0.5, 0≦z≦0.5, and 0≦w≦2;
wherein M is at least one element selected from the group consisting of Al, Ni, Co, Mn, Cr, Fe, Mg, Sr, V, and rare earth elements;
wherein A is an element selected from the group consisting of O, F, S, and P; and
wherein X is one of F, S, and P.

32. The lithium secondary battery of claim 30, wherein electrolyte comprises at least one organic solvent.

33. The lithium secondary battery of claim 30, further comprising lithium salt selected from the group consisting of LiPF₆, LiBF₄, LiSbF₆, LiAsF₆, LiCF₃SO₃, LiN(CF₃SO₂)₃, Li(CF₃SO₂)₂N, LiC₄F₉SO₃,LiClO₄, LiAlO₄, LiAlCl₄, LiN(CₘF₂ₘ₊₁SO₂)(CₙF₂ₙ+1SO₂) (where the m and n are natural numbers), LiCl, and LiI.
